(19) United States
(12) Patent Application Publication
(10) Pub. No.: US 2004/0071604 A1
(43) Pub. Date: Apr. 15, 2004

(54) Container for reagents for the analysis by various analytical methods,method for producing a measuring vessel, measuring vessel and use of said measuring vessel

(76) Inventors: Hans-J?uuml;rgen Kolde, (US); Holger Eggert, Gr?auml;felfing (DE)

Correspondence Address: Dike Bronstein Roberts & Cushman, Edwards & Angell, Intellectual Property Practice Group, P O Box 9169, Boston, MA, 02209, US

(21) Appl. No.: 10/468,974

(22) PCT Filed: Feb. 27, 2002
(86) PCT No.: PCT/EP02/02100

(30) Foreign Application Priority Data
Feb. 27, 2001 (EP) 01104779.2

(51) Int. Cl. B01L 3/00; G01N 1/00

(52) U.S. Cl. 422/102; 436/174

(57) ABSTRACT

A container (1) is provided, which serves as reagent support and measuring vessel for analysis using various analytical processes, and has a region which is divided into at least two chambers (9a, 9b, 9c) by one or more bars (8) extending from the container wall (5) or the container base (4), wherein the chambers are arranged so that liquid or solid reagents may be introduced therein without them being able to be mixed by diffusion or running into one another. The container is used for drying or freeze-drying by with completely or partly filled chambers and serves at the same time as a measuring vessel after re-dissolving the dried material by adding water, reagent solution, or the sample present in aqueous phase.

Container for reagents for analysis by various analytical methods, method for producing a measuring vessel, measuring vessel and use of said measuring vessel

The invention relates to a container for receiving reagents for analysis using various analytical processes, a process for producing a measuring vessel, a measuring vessel and a use of such a measuring vessel.

In a known process for measuring the coagulation properties of blood, coagulation is ascertained via measurement of a relative movement of a cuvette containing a blood sample relative to a punch. To carry out various tests on the blood sample, one or more reagents are added to the latter. The reagents are conventionally present in liquid form and are held in stock in larger quantities by the laboratories or hospitals executing the tests. Often, the entire stock quantity of reagent is not consumed for a test series, so that the reagent disintegrates, which is uneconomical. This problem also occurs in other analysis processes, in particular medical, biochemical and those relating to environmental or foodstuff analysis.

It is the object of the invention to provide a container for receiving reagents for analysis using various analytical processes, a process for producing a measuring vessel, a measuring vessel and a use of such a measuring vessel, which permits tests which are simple to manage and which increases the economic viability of the tests.

The object is achieved by a container according to patent claim 1, a method according to patent claim 14, a measuring vessel according to patent claim 16 and the use of such according to patent claim 17 or 18.

Further developments of the invention are indicated in the sub-claims.

An important aspect of the invention is that the quantity of reagent necessary for the particular test is made available directly in the container. The reagents may be present in solid form, for example dried or lyophilised.

Further features and advantages of the invention can be seen from the description of embodiments using the figures.

Of the figures:

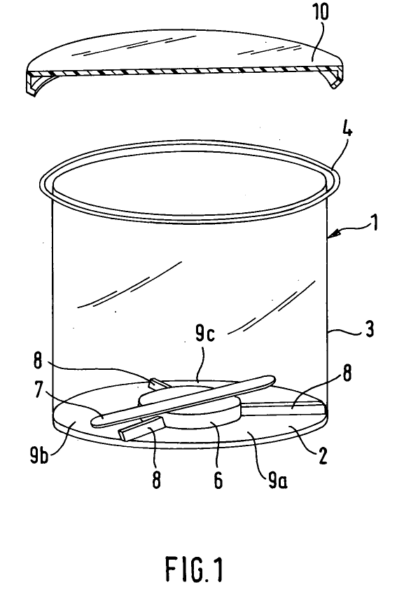

FIG. 1: shows a schematic view of the container of the invention in a first embodiment;

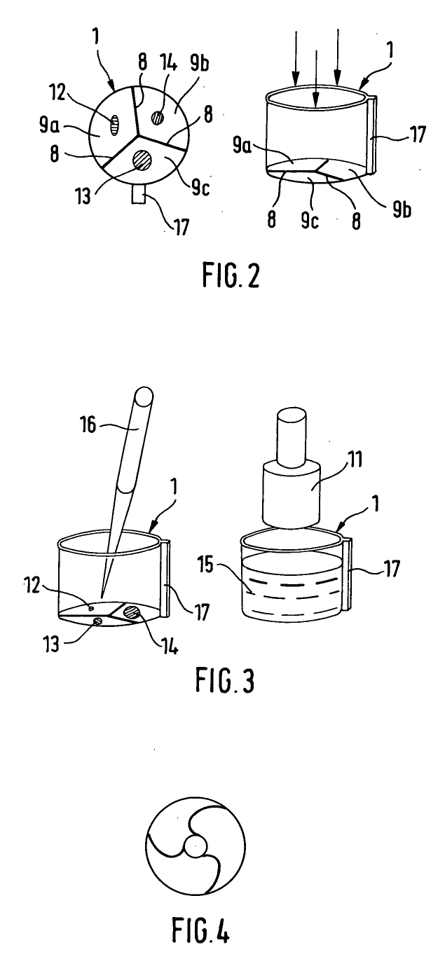

FIG. 2: shows a schematic representation of the production of a test vessel according to the invention;

FIG. 3: shows a schematic representation of carrying out a test;

FIG. 4: shows a plan view of the container of the invention in a further embodiment;

FIG. 5: shows a plan view of a lid for the container of the invention in a further embodiment;

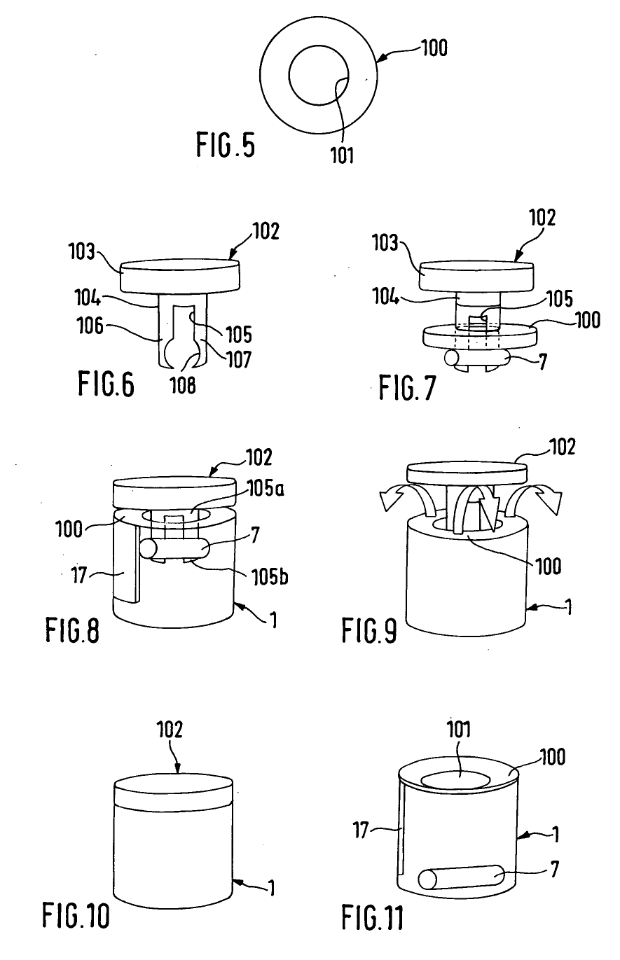

FIG. 6: shows a schematic perspective view of a closure element for the lid according to FIG. 5;

FIG. 7: shows a schematic view of the lid of FIG. 5 with inserted closure element according to FIG. 6;

FIG. 8: shows a schematic representation of the lid with closure element according to FIGS. 5 to 7 in the state placed on the container;

FIG. 9: shows a schematic representation of the mode of operation of the closure element according to FIG. 6;

FIG. 10: shows a view of the container with the lid according to FIGS. 5 to 9 in closed representation; and

FIG. 11: shows a view of the container with lid according to FIG. 5 and removed closure element.

As can be seen from FIG. 1, the container 1 of the invention is designed as a cuvette in a first embodiment. Such a cuvette can be used, for example in a device for measuring the coagulation properties of blood and other test liquids. The cuvette has an essentially flat base 2 and a cylindrical wall 3 extending from the latter with an upper edge 4. In the interior of the cuvette, a support 6 is designed on the base 2, on which a rod-like magnetic stirrer or stirring fish 7 made from stainless steel or soft iron rests. In the embodiment shown in FIG. 1, essentially linear bars 8, by means of which chambers 9a, 9b, 9c next to one another are formed on the base, extend starting from the support 6 in radial direction as far as the cylindrical wall 3. The height of the bars is low compared to the height of the cylindrical wall. For the embodiment described, in which the cuvette is used for measuring the coagulation properties of blood, the height of the bars is only about 1 mm. For an internal diameter of the cuvette of about 0.8 cm, the volume of the chambers available for the reagents is about 15-20 μl. The height of the support 6 is so much greater than the height of the bars 8 that the stirring fish 7 may be rotated freely. An electromotor not shown is provided as drive for the stirring fish. Control of the stirring device is continuous or intermittent.

The cuvette is formed from a material which is not attacked by the reagents to be introduced and the blood or the test liquid, for example from plastic. The support 6 and the bars 8 are formed preferably integrated with the cuvette base 2.

The cuvette can be closed by a lid 10 at its open end.

In operation, in a first step as shown in FIG. 2, the reagents 12, 13, 14 are filled into the chambers 9a, 9b, 9c on the cuvette base 2 by means of a multi-compartment dispenser or a pipetting machine in the required quantities which are a few μl, wherein flowing together of the reagents is prevented by the bars 8. The drops of reagent introduced are then dried or lyophilised in the cuvette.

To measure the coagulation properties of blood or a different test liquid, the dried or lyophilised reagents are dissolved, as shown in FIG. 3, by filling in the blood sample 15 itself or by previous partial dissolving with water by means of a pipette 16. The cuvette is then inserted into the device to measure the coagulation properties, wherein a punch 11 is immersed in the sample. The coagulation properties are then measured in known manner by measuring the relative rotary movement of the punch with respect to the cuvette. Mixing of the blood sample 15 with the reagents 12, 13, 14 is effected before and during the measurement by the movement of the stirring fish 7.

Modifications of the container 1 are possible. Although the cylindrical shape is suitable for the process of measuring the coagulation properties of blood or a different test liquid via the relative movement of cuvette and punch, the shape of the cuvette does not necessarily have to be cylindrical for other analysis processes. For the measurement via determination of the absorption or fluorescence or luminescence of light passed through for example, it is advantageous that the cuvette has flat lateral surfaces. The base may also be arched, for example concavely. A suitable number of bars, which produce the chambers, is provided depending on intended application or number of reagents required. Their height is designed depending on the required chamber volumes and the number of required reagents. The support 6 with the stirring fish 7 is not necessarily required, but advantageous. For some applications, a stirring fish is not absolutely necessary. In a further development, the cuvette has a shoulder 17 on its side wall, which serves to engage and position the cuvette and which may contain a code, for example a bar code and/or colour code for marking the cuvette. The shoulder is designed so that the container is clearly positioned by it in a measuring device or during filling and thus serves as positioning device or stop.

In an embodiment shown in FIG. 4, the bars are not designed to be linear, but curved, for example corrugated or shaped like a propeller, as a result of which dissolving of the reagents present in the chambers may be improved by additional swirling.

In a further embodiment of the invention shown in FIGS. 5 to 11, the lid or the cover 100 is designed with a central opening 101, as shown in FIG. 5, into which a closure element in the form of a lyophilisation stopper 102, as shown in FIG. 6, can be inserted. The lyophilisation stopper 102 has a head 103 having a diameter which is greater than the diameter of the opening 101, so that the head may completely cover the opening, and a closure section 104 for insertion into the opening 101 and for closing the same. The outer diameter of the head 103 is, for example as large as the external diameter of the lid, so that the stopper in the placed-on state terminates externally flush with the lid. The outer diameter of the closure section is such that the closure section 104 passes exactly through the opening 101 and closes the latter. The closure section 104 is designed to be slotted, having a slot 105, which extends starting from a distance from the head 103 as far as the end of the closure section opposite the head. Two limbs 106, 107, which can be bent resiliently relative to one another to a certain extent, are formed by the slot 105. On its end facing away from the head 103, the slot 105 has a cylindrical widening 108 having a diameter which corresponds approximately to the diameter of the stirring rod or stirring fish 7, to receive the stirring rod 7. Due to the elasticity of the limbs, the stirring rod 7 can be clamped into the closure part. The length of the stirring rod is greater than the diameter of the opening 101 in the lid 100.

In operation, as shown in FIG. 7, first of all the lyophilisation stopper 102 is passed through the opening 101 of the lid or pressed into the lid, if the lid is not yet placed on the cuvette or the container 1. Pressing-in takes place until in each case a section 105a, 105b of the slot 105 is still situated above or below the lid 100. Then the stirring rod 7 is clamped between the limbs of the stopper. The lid together with the stopper and the stirring rod firmly clamped thereto is then pressed onto the cuvette, in which liquid reagents are already situated in the chambers. Lyophilisation is then carried out, wherein vapours being produced, as shown in FIGS. 8 and 9, may escape via the slot sections 105a, 105b. The stopper, as shown in FIG. 10, is then pressed completely into the lid to close the cuvette, so that the slot 105 lies completely within the container and the container is closed. The stirring rod is thus still held on the stopper. The cuvette thus closed is welded, for example into a bag, on which the expiry date is indicated. The lyophilisation stopper is removed for use. The stirring rod thus falls into the cuvette. The sample to be measured may be introduced through the opening which is now exposed.

The cover of the invention is not restricted to the fact that it is used together with a cuvette which has the chambers described above. It may also serve for other measuring vessels which do not have chambers.

For measuring the coagulation properties of blood, the cuvette described and the process described has the advantage that only one or two exact pipetting actions are necessary. Furthermore, reagent losses and decay of reagents do not occur. The cuvette is simple to produce, may be filled using a standard filling machine and may be placed in a traditional drier or lyophiliser. Instead of the expense in the production of liquid reagents, particularly for combinations, filling may be effected in separate form. This also facilitates simple handling of labile substances, such as for example various enzymes which can be stabilised in solution often only expensively in certain combinations. The production of the cuvette is associated with only low costs.

The use of the container 1 described above is not restricted to the field of measuring coagulation properties of blood or other test liquids. The container 1 may also be used for other analysis processes, for example in clinical or foodstuff analysis. A method of the invention for producing a measuring vessel for any analyses comprises the provision of a container described above, filling of the reagents into the corresponding chambers, drying or lyophilisation of the reagents introduced and the provision of the container with a lid, which may also be designed, for example as a welded-on film. The measuring vessels produced in this way may be provided in larger quantities and permit implementation of the analysis without stock-holding of liquid reagents. The container of the invention thus serves as combined reagent support and as measuring vessel.

1. Container for receiving reagents for analysis using various analytical processes, characterised in that the container (1) has a region which is divided into at least two chambers (9a, 9b, 9c), wherein the chambers are designed so that they have an opening towards the container interior for introducing liquid or solid reagents separately from one another, and in that it serves at the same time as a measuring vessel.

2. Container according to claim 1, characterised in that the container (1) has a base (4) and a wall (5) extending from the latter, wherein the chambers (9a, 9b, 9c) are formed by at least one bar (8) running on the base.

3. Container according to claim 2, characterised in that the height of the bar (8) is small compared to the height of the container wall (5).

4. Container according to one of claims 2 or 3, characterised in that the container is designed to be essentially cylindrical and in that the bar or bars (8) run in radial direction and are either linear or curved.

5. Container according to one of claims 1 to 4, characterised by a stirring device (7) provided in the container.

6. Container according to claim 5, characterised in that the stirring device is designed as a stirring fish (7).

7. Container according to claim 6, characterised in that a support (6) for supporting the stirring fish is provided on the container base, wherein the height of the support is slightly greater than the height of the bars.

8. Container according to claim 7, characterised in that an engagement shoulder (17) is provided on the outer wall (5) of the container (1).

9. Container according to one of claims 1 to 8, characterised in that the container can be closed by a cover (10).

10. Container according to claim 9, characterised in that the cover (100) has an opening (101) which can be closed by a closure element (102).

11. Container according to claim 10, characterised in that the closure element (102) has a device (105, 106) for holding a stirring device (7).

12. Container according to claim 11, characterised in that the closure element is designed as a stopper (102) which has a slot (105) at its end pointing into the container interior in the inserted state, wherein a stirring rod (7) is held in the slot (105).

13. Container according to claim 12, characterised in that the length of the stirring rod (7) is greater than the diameter of the opening (101) in the cover.

14. Method for producing a measuring vessel for analysis using various analytical processes having the steps:
provision of a container (1) according to one of claims 1 to 13;
introducing liquid or solid reagents (12, 13, 14) into the chambers (9a, 9b, 9c), so that the latter are completely or partly filled;
drying or lyophilising the reagents introduced;

15. Method according to claim 14, characterised in that the container is closed by a cover (10) after drying or lyophilising.

16. Measuring vessel, characterised in that it is produced according to one of claims 14 or 15.

17. Use of a container according to one of claims 1 to 13 for analysis of test liquids, in particular of blood or anti-coagulated blood or of plasma.

18. Use of a measuring vessel, which is produced according to one of claims 14 or 15, in a process for measuring the coagulation properties of test liquids, in particular of blood or anti-coagulated blood or of plasma.

19. Cover for a container according to one of claims 1 to 9, characterised in that the cover is designed according to one of claims 10 to 13.
